(19) United States
(12) Patent Application Publication
(10) Pub. No.: US 2015/0103750 A1
(43) Pub. Date: Apr. 16, 2015

(54) METHODS AND APPARATUS FOR ENHANCED DOWNLINK COMMUNICATION

(71) Applicant: QUALCOMM Incorporated, San Diego, CA (US)

(72) Inventors: Tom CHIN, San Diego, CA (US); Shouwen LAI, San Diego, CA (US); Kuo-Chun LEE, San Diego, CA (US); Wei ZHANG, San Diego, CA (US)

(73) Assignee: QUALCOMM Incorporated, San Diego, CA (US)

(21) Appl. No.: 14/051,873

(22) Filed: Oct. 11, 2013

(51) Int. Cl. H04W 72/04; H04L 5/00

(52) U.S. Cl. CPC H04W 72/042; H04L 5/0096
USPC 370/329

(57) ABSTRACT

Methods and apparatus for wireless communication at a user equipment (UE) include sending a downlink enhancement message to a network entity when a downlink enhancement condition has been detected. Further, the methods and apparatus include receiving communication from the network entity in response to sending the downlink enhancement message. Moreover, methods and apparatus for wireless communication at a network entity include detecting a downlink enhancement condition. Additionally, the methods and apparatus include transmitting a network entity originated downlink enhancement message to a UE in response to detecting the downlink enhancement condition.

### BACKGROUND

Aspects of the present disclosure relate generally to wireless communication systems, and more particularly, to enhanced downlink communication.

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associated UMTS networks.

As the demand for mobile broadband access continues to increase, research and development continue to advance the UMTS technologies not only to meet the growing demand for mobile broadband access, but to advance and enhance the user experience with mobile communications.

In some wireless communication networks, underutilization of available communication resources, particularly communication on the downlink, may often lead to degradations in wireless communication. Even more, the foregoing resource underutilization inhibits user equipments from achieving higher wireless communication quality through, for example, an increase in available bandwidth. Thus, improvements in downlink communication are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, a method of wireless communication at a user equipment (UE) comprises sending a downlink enhancement message to a network entity when a downlink enhancement condition has been detected. Further, the method comprises receiving communication from the network entity in response to sending the downlink enhancement message.

Further aspects provide a computer program product for wireless communication at a UE comprising a computer-readable medium that includes at least one instruction for sending a downlink enhancement message to a network entity when a downlink enhancement condition has been detected. Further, the computer-readable medium includes at least one instruction for receiving communication from the network entity in response to sending the downlink enhancement message.

Additional aspects provide an apparatus for wireless communication at a UE comprises means for sending a downlink enhancement message to a network entity when a downlink enhancement condition has been detected. Further, the apparatus comprises means for receiving communication from the network entity in response to sending the downlink enhancement message.

In another aspect, an apparatus for wireless communication at a UE comprises a downlink enhancement component configured to send a downlink enhancement message to a network entity when a downlink enhancement condition has been detected. Further, the downlink enhancement component is further configured to receive communication from the network entity in response to sending the downlink enhancement message.

In an additional aspect, a method of wireless communication at a network entity comprises detecting a downlink enhancement condition. Further, the method comprises transmitting a network entity originated downlink enhancement message to a UE in response to detecting the downlink enhancement condition.

Further aspects provide a computer program product for wireless communication at a network entity comprising a computer-readable medium that includes at least one instruction for detecting a downlink enhancement condition. Moreover, the computer-readable medium includes at least one instruction for transmitting a network entity originated downlink enhancement message to a UE in response to detecting the downlink enhancement condition.

Another aspect of the disclosure provides an apparatus for wireless communication at a network entity comprises means for detecting a downlink enhancement condition. Further, the apparatus comprises means for transmitting a network entity originated downlink enhancement message to a UE in response to detecting the downlink enhancement condition.

Additional aspects provide an apparatus for wireless communication at a network entity comprising a network entity downlink enhancement component configured to detect a downlink enhancement condition. Further, the network entity downlink enhancement component is further configured to transmit a network entity originated downlink enhancement message to a UE in response to detecting the downlink enhancement condition.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 is a schematic diagram of a communication network including an aspect of a user equipment and a network entity that may enhance downlink communication;

FIG. 2 is a schematic diagram of an aspect of the communication component of FIG. 1;

FIG. 3 is a schematic diagram of an aspect of the network entity communication component of FIG. 1;

FIG. 4a is a conceptual diagram of a downlink time slot arrangement;

FIG. 4b is a conceptual diagram of a downlink time slot arrangement, according to FIG. 1;

FIG. 5 is a flowchart of an aspect of the downlink enhancement features at a user equipment, according to FIG. 1;

FIG. 6 is a flowchart of an aspect of the downlink enhancement features at a network entity, according to FIG. 1;

FIG. 7 is a block diagram conceptually illustrating an example of a wireless communication system including an aspect of the user equipment and network entity described herein;

FIG. 8 is a block diagram conceptually illustrating an example of a frame structure in a wireless communication system including an aspect of the user equipment and network entity described herein;

FIG. 9 is a block diagram conceptually illustrating an example of the network entity of FIG. 1, in communication with the user equipment of FIG. 1, in a wireless communication system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The present aspects generally relate to enhancements in downlink wireless communication. Specifically, in some communication technology types (e.g., TD-SCDMA), particular channels (e.g., P-CCPCH) may be designated with certain predefined communication characteristics. For example, in time division technology types, communication may be facilitated by way of time slots (TS). In some aspects, time slot zero (TS0) may be utilized to transmit Primary Common Control Physical Channel information (P-CCPCH). P-CCPCH may be utilized to communicate system information and/or measure one or more signal characteristics such as receive signal code power (RSCP). Further, TS0 may normally be employed to obtain inter/intra frequency measurements at every occurrence within a subframe. That is, a user equipment (UE) may obtain inter/intra frequency measurements at every TS0 occurrence to facilitate, for example, cell reselection and/or handover. However, in some non-limiting cases, TS0 measurements at every occurrence in a subframe may be deemed excessive. As such, according to the present apparatus and methods, an adjustment of TS0 measurement frequency may be made to enhance downlink communication on one or more downlink communication channels. Accordingly, in some aspects, the present methods and apparatuses may provide an efficient solution, as compared to current solutions, to efficiently utilize TS0 for downlink data communication.

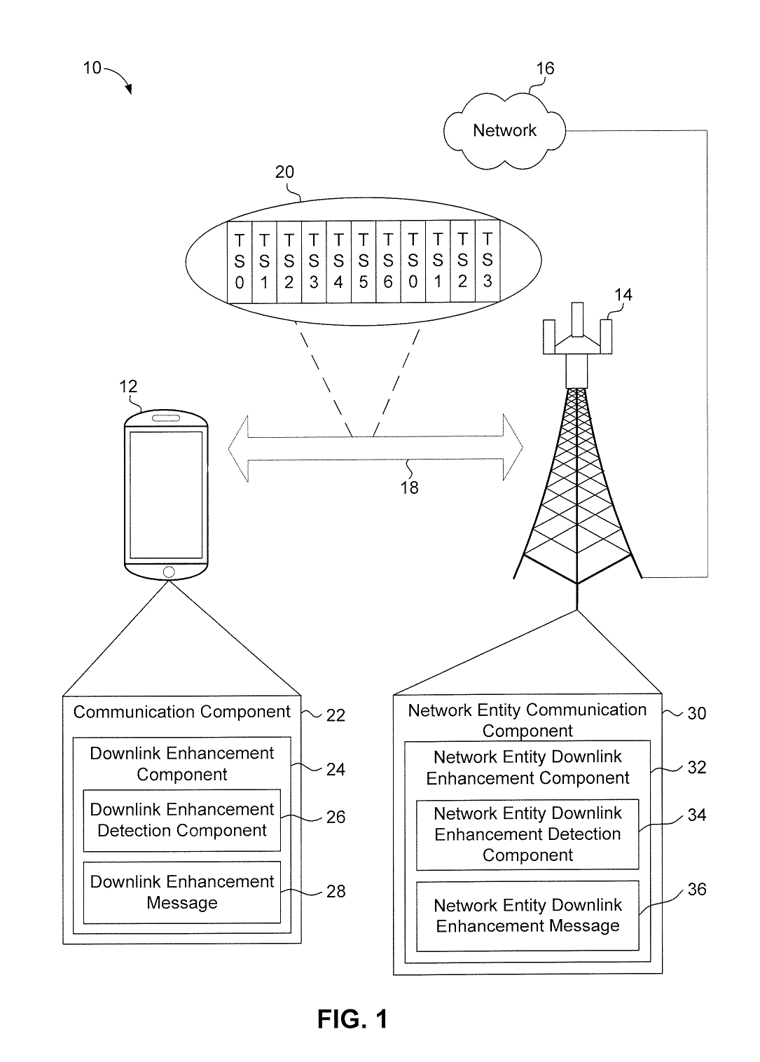

Referring to FIG. 1, in one aspect, a wireless communication system 10 includes at least one UE 12 in communication coverage of at least one network entity 14 (e.g., base station). UE 12 may communicate with network 16 by way of, for instance, network entity 14. Further. UE 12 may communicate with network entity 14 via one or more communication channels 18 utilizing one or more air interfaces (e.g., TD-SCDMA). In such aspects, the one or more communication channels 18 may enable communication on both the uplink and downlink. For example, communication may be received by the UE 12 from the network entity 14 on the downlink communication channel of communication channel 18. In some aspects, data communicated on the downlink (e.g., to UE 12) may be utilize one or more of a downlink dedicated physical channel (DL-DPCH), a high-speed downlink packet access (HSDPA) and a high-speed-physical downlink shared channel (HS-PDSCH) to communicate data on one or more time slots including, but not limited to, TS0. Communication using the aforementioned example channels may be conducted by way of a time division arrangement (e.g., time slots 20). Time slots 20 may include one or more frames (e.g., TD-SCDMA frame) each including one or more subframes for communicating measurement and/or data along one or more communication channels (e.g., communication channel 18).

In some aspects, UE 12 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a terminal, a user agent, a mobile client, a client, or some other suitable terminology. Additionally, network entity 14 may be a macrocell, picocell, femtocell, relay, Node B, mobile Node B, UE (e.g., communicating in peer-to-peer or ad-hoc mode with UE 12), or substantially any type of component that can communicate with UE 12 to provide wireless network access at the UE 12.

According to the present aspects, UE 12 may include communication component 22, which may be configured to facilitate wireless communication with at least one network entity (e.g., network entity 14). For example, communication component 22 may enable UE 12 to communicate with network entity 14 on one or more downlink data communication channels (e.g., DPCH, HSDPA & HS-PDSCH). Further, communication on the one or more downlink communication channels may be conducted using time slots (e.g., time division multiplexing).

In an aspect, communication component 22 may include downlink enhancement component 24, which may be configured to enhance downlink communication between UE 12 and network entity 14 by adjusting the frequency of TS0 measurements occurring per frame. In other words, downlink enhancement component 24 may be configured to increase the bandwidth allocated for downlink data communication by decreasing the TS0 measurement periodicity. For example, downlink enhancement component 24 may adjust communication parameters such that downlink communication on TS0 includes data transmission on one or more downlink data communication channels.

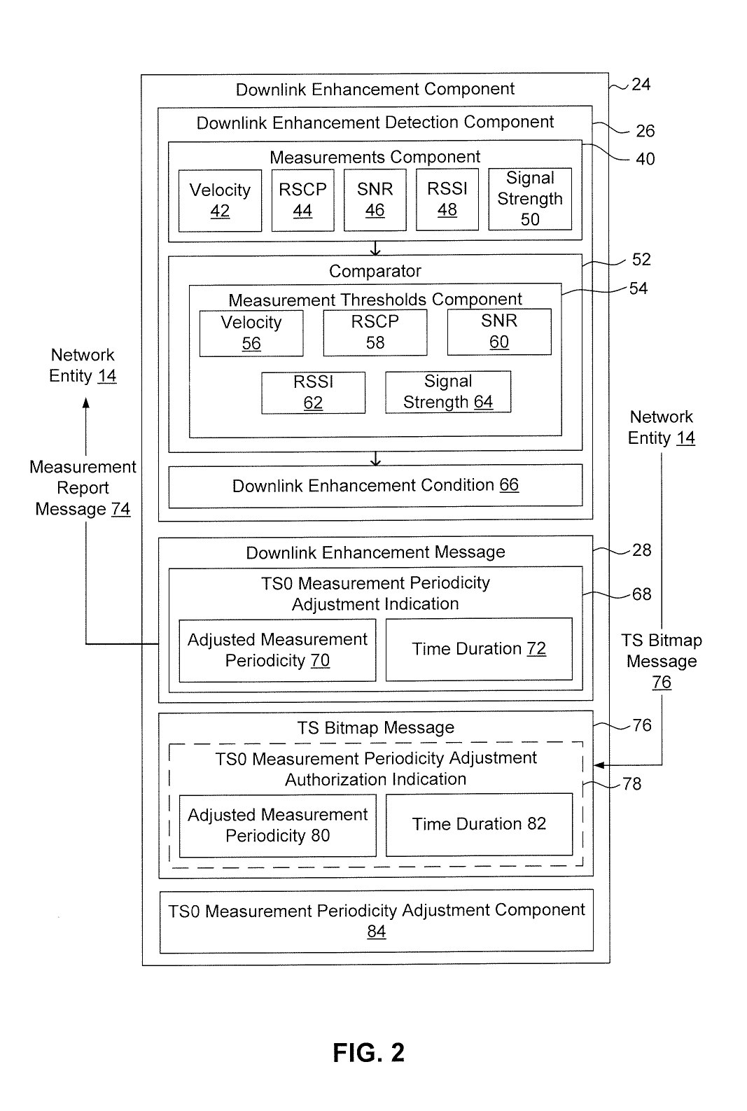

In a further aspect, downlink enhancement component 24 may include downlink enhancement detection component 26, which may be configured to detect a downlink enhancement condition. In some aspects, downlink enhancement condition may indicate satisfaction of one or more UE measurement comparisons (e.g., signal strength and/or velocity), and as such, trigger the transmission of a downlink enhancement message 28 to network entity (e.g., network entity 14). For example, downlink enhancement detection component 26 may determine or otherwise detect a downlink enhancement condition that may indicate to one or both of downlink enhancement component 24 and communication component 22 to communicate downlink enhancement message 28 to network entity 14 for subsequent downlink enhancement determinations. For example, downlink enhancement detection component 26 may compare one or more UE measurements so as to determine the downlink enhancement condition, which may represent a suitable communication state (e.g., strong signal strength) to permit or otherwise trigger an enhancement of downlink communication. Further aspects of downlink enhancement component 24 are described herein with respect to FIG. 2.

Furthermore, network entity 14 may include network entity communication component 30, which may be configured to facilitate wireless communication with at one or more UEs (e.g., UE 12). For example, network entity communication component 30 may enable network entity 14 to communicate with UE 12 on one or more downlink data communication channels (e.g., DPCH, HSDPA & HS-PDSCH). Further, communication on the one or more downlink communication channels may be conducted using time slots (e.g., time division multiplexing).

In an aspect, network entity communication component 30 may include network entity downlink enhancement component 32, which may be configured to proactively enhance downlink communication between network entity 14 and UE 12 by adjusting the frequency of TS0 measurements occurring per frame. For example, network entity 14 may instruct or otherwise indicate to UE 12 to adjust inter/intra frequency measurements conducted at or by UE 12. Hence, network entity downlink enhancement component 32 may be configured to increase the bandwidth allocated for downlink data communication by decreasing the TS0 measurement periodicity. For example, network entity downlink enhancement component 32 may adjust communication parameters such that downlink communication on TS0 includes data transmission on one or more downlink data communication channels.

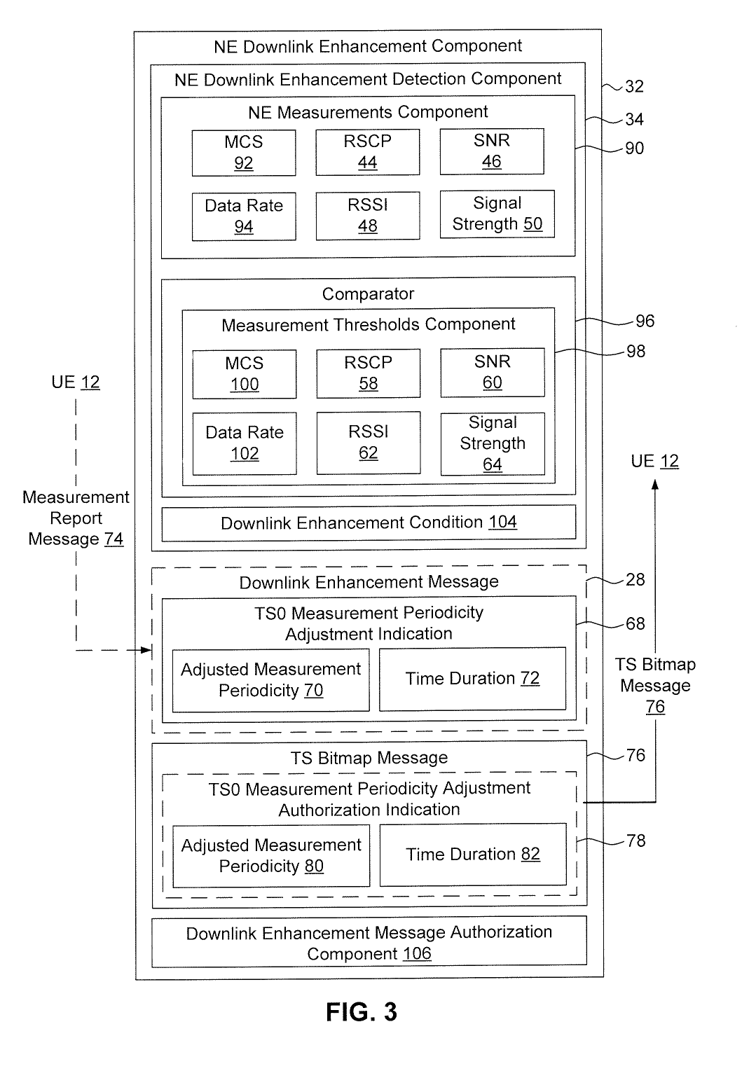

In a further aspect, network entity downlink enhancement component 32 may include network entity downlink enhancement detection component 34, which may be configured to detect a downlink enhancement condition. In some aspects, downlink enhancement condition may indicate satisfaction of one or more measurement comparisons at the network entity 14 (e.g., UE signal strength and/or UE velocity), and as such, trigger the transmission of a network entity downlink enhancement message 36 to one or more UEs (e.g., UE 12). For example, network entity downlink enhancement detection component 34 may determine or otherwise detect a downlink enhancement condition that may indicate to one or both of network entity downlink enhancement component 32 and network entity communication component 30 to communicate a downlink enhancement message 36 to UE 12 for subsequent downlink enhancement determinations. For example, network entity downlink enhancement detection component 34 may compare one or more UE measurements so as to determine the downlink enhancement condition, which may represent a suitable communication state (e.g., strong signal strength) to permit or otherwise trigger an enhancement of downlink communication. Further aspects of network entity downlink enhancement component 32 are described herein with respect to FIG. 3.

Referring to FIG. 2, an aspect of the downlink enhancement component 24 of UE 12 may include various components and/or subcomponents, which may be configured to enhance downlink communication with a network entity (e.g., network entity 14, FIG. 1) by adjusting the frequency of TS0 measurements occurring per frame. Further, for example, downlink enhancement component 24 may be configured to send a downlink enhancement message 28 to a network entity (e.g., network entity 14, FIG. 1) when a downlink enhancement condition 66 has been detected, and to receive communication (e.g., TS bitmap message 76) from the network entity in response to sending the downlink enhancement message 28.

As described herein, downlink enhancement component 24 may include downlink enhancement detection component 26, which may be configured to detect or otherwise determine a downlink enhancement condition 66. In further aspects, downlink enhancement detection component 26 may include measurements component 40, which may be configured to determine and store one or more measurements made by one or more components of a UE (e.g., UE 12, FIG. 1). In some aspects, measurements component 40 may determine and store measurements related to the velocity value 42 of a UE (e.g., UE 12, FIG. 1). For example, a UE may include an accelerometer, global positioning system device, and/or any other electronic component configured to determine UE velocity. Further, measurements component 40 may determine and store the received signal code power (RSCP) 44. For example, measurements component 40 may be configured to determine the received power on the P-CCPCH. In addition, measurements component 40 may be configured to determine and store the signal-to-noise (SNR) ratio 46. For example, measurements component 40 may be configured to determine the SNR 46 experienced at UE 12 (FIG. 1). Moreover, measurements component 40 may be configured to determine and store the received signal strength indicator (RSSI) 48. For instance, measurements component 40 may determine the total received power observed by a UE (e.g., UE 12, FIG. 1) from all sources, including co-channel serving and non-serving cells, adjacent channel interference and thermal noise within the measurement bandwidth. Furthermore, measurements component 40 may be configured to determine and store one or more additional measurements related to a UE signal strength 50. For example, UE 12 (FIG. 1) may determine a detected signal strength of one or more network entities (e.g., including network entity 14) based on a unit of measurement.

In additional aspects, downlink enhancement detection component 40 may include comparator 52, which may be configured to compare one or more measurements received or otherwise obtained from the measurements component 40 with one or more corresponding measurement thresholds 54. Comparator 52 may determine and/or store thresholds in measurement threshold component 54, including, but not limited to, a UE velocity threshold value 56 corresponding to the measured UE velocity value 42, an RSCP threshold value corresponding to the measured RSCP value 44, an SNR threshold value 60 corresponding to a measured SNR value 46, an RSSI threshold value 62 corresponding to a measured RSSI value 48 and a signal strength threshold value 64 corresponding to a measured signal strength value 50. For example, comparator 52 may be configured to determine whether a measured signal strength value 50 meets or exceeds a signal strength threshold value 64. Further, for instance, comparator 52 may be configured to determine whether the UE velocity 42 is below a UE velocity threshold value 56. Moreover, when comparator 52 determines that at least one threshold condition is met, comparator 52 signals or otherwise provides a downlink enhancement condition 66 so as to trigger the transmission of downlink enhancement message 28. In other words, downlink enhancement detection component 26 through the operation of comparator 52 and generation of downlink enhancement condition 66 may determine the adequate condition or conditions for adjusting TS0 measurement periodicity.

In further aspects, downlink enhancement component 24 may be configured, upon detection of downlink enhancement condition 66, to send a downlink enhancement message 28 to a network entity (e.g., network entity 14, FIG. 1). For example, the downlink enhancement message 28 may be transmitted to the network entity 14 (FIG. 1) within or via a radio resource (RRC) measurement report message 74. Further, downlink enhancement message 28 may include a TS0 measurement periodicity adjustment indication 68, which may, among other aspects, indicate to the network entity, a request for an adjusted measurement periodicity 70 and a defined time duration 72 for such adjustment. That is, in some aspects, the TS0 measurement periodicity adjustment indication 68 may request network authorization (e.g., from network entity 14, FIG. 1) of an adjustment of a frequency of TS0 measurements per frame, e.g., adjusted measurement periodicity 70, for the defined time duration 72. For instance, the defined time duration may be specified in any unit of time (e.g., seconds, milliseconds) and/or may be specified by a number of frames and/or subframes. Further, the defined time duration 72 may be based on one or both of communication measurements and UE velocity (e.g., provided or determined by downlink enhancement detection component 26). For example, if based on the comparison the velocity value 42 is zero or much lower than the velocity threshold value 56, the defined time duration 72 may be higher (e.g., 10 frames or 50 ms) as opposed to when the velocity value 42 is slightly lower than the velocity threshold value 56 (e.g., 5 frames or 25 ms). The same or similar may be the case for any UE measurement described herein to determine the defined time duration. Moreover, the TS0 measurement periodicity adjustment indication 68 permits downlink allocation on at least one TS0 for the defined time duration 72. For example, downlink enhancement component 24 may transmit downlink enhancement message 28 including TS0 measurement periodicity adjustment indication 68 to network entity 14 requesting an adjusted TS0 measurement periodicity 70 (e.g., one TS0 measurement per frame) for a defined time duration 72 (e.g., five frames or 50 ms).

Additional aspects of the downlink enhancement component 24 may include time slot (TS) bitmap message 76, which may be received subsequent to communication of downlink enhancement message 28 requesting network authorization of a TS0 measurement periodicity adjustment. For example, upon communication of the downlink enhancement message 28 including TS0 measurement periodicity adjustment indication 68, network entity (e.g., network entity 14) may determine whether to authorize the TS0 measurement periodicity adjustment for the defined time duration 72. Downlink enhancement component 24 may obtain or otherwise receive TS bitmap message 76. In some cases, TS bitmap message 76 may optionally include TS0 measurement periodicity adjustment authorization indication 78 authorizing downlink enhancement component 24 to adjust the TS0 measurement periodicity to the received adjusted measurement periodicity 80 for the indicated defined time duration 82 (e.g., defined time value may be designated in milliseconds or number of frames/subframes). In some aspects, the received adjusted measurement periodicity 80 and the defined time duration 82 may be the same as or different from the adjusted measurement periodicity 70 and defined time duration 72 included in the downlink enhancement message 28. In other words, in some cases, the network entity 14 may determine a different adjusted measurement periodicity 80 than the adjusted measurement periodicity 70 provided by the UE and/or a different defined time duration 82, as compared to the defined time duration 72, for the adjustment.

Further, in an aspect, the existence or absence of the TS0 measurement periodicity adjustment authorization indication 78 in the TS bitmap message 76 may indicate whether or not the downlink enhancement component 24 is authorized to adjust the TS0 measurement periodicity and/or the defined time duration. That is, the existence or absence of TS0 measurement periodicity adjustment authorization indication 78 may permit or not permit, respectively, an adjustment of a frequency of TS0 measurements per frame (e.g., adjusted measurement periodicity 70 or 80) for a defined time duration 72 or 82. Hence, for example, the TS bitmap message 76 may include a TS0 measurement periodicity authorization indication 78 when permitting an adjustment of the frequency of TS0 measurement per frame for the defined time duration. Further, for instance, the TS bitmap message 76 may include an absence of a TS0 measurement periodicity adjustment authorization indication 78 when not permitting an adjustment of the frequency of TS0 measurement per frame for the defined time duration.

Further aspects of downlink enhancement component 24 include TS0 measurement periodicity adjustment component 84, which may be configured to adjust TS0 measurement periodicity for a defined time duration based on the received TS0 measurement periodicity adjustment authorization indication 78 and included parameters (e.g., adjusted measurement periodicity 80 and defined time duration 82). For example, upon receiving TS bitmap message 76 including TS0 measurement periodicity adjustment authorization indication 78, TS0 measurement periodicity adjustment component 84 may extract and adjust the TS0 measurement periodicity based on the adjusted measurement periodicity 80 for the defined time duration 82.

Referring to FIG. 3, an aspect of the network entity downlink enhancement component 32 may include various components and/or subcomponents, which may be configured to enhance downlink communication with a UE (e.g., UE 12, FIG. 1) by transmitting a message authorizing adjustment of the frequency of TS0 measurements occurring per frame. Further, for example, network entity downlink enhancement component 32 may be configured to detect a downlink enhancement condition 104, and transmit a downlink enhancement message to a UE in response to detecting the downlink enhancement condition 104.

As described herein, network entity downlink enhancement component 32 may include network entity downlink enhancement detection component 34, which may be configured to detect or otherwise determine a downlink enhancement condition 104. In further aspects, network entity downlink enhancement detection component 34 may include network entity measurements component 90, which may be configured to determine and store one or more measurements made by one or more components of a UE (e.g., UE 12, FIG. 1) or network entity (e.g., network entity 14, FIG. 1).

In some aspects, network entity measurements component 90 may determine and store measurements related to a modulation and coding scheme (MCS) value 100. The MCS value may be derived from or associated with the high speed shared control channel (HS-SCCH) data rate. For example the determined MCS value 100 may indicate the information data rate of a transmission on the downlink. Further, one or more additional data rate values may be determined and stored. Further, measurements component 40 may determine and store the received signal code power (RSCP) 44. For example, network entity measurements component 90 may be configured to determine the received power on the P-CCPCH. In addition, network entity measurements component 90 may be configured to determine and store the signal-to-noise (SNR) ratio 46. For example, network entity measurements component 90 may be configured to determine the SNR 46 experienced at UE 12 (FIG. 1). Moreover, network entity measurements component 90 may be configured to determine and store the received signal strength indicator (RSSI) 48. For instance, network entity measurements component 90 may determine the total received power observed by a UE (e.g., UE 12, FIG. 1) from all sources, including co-channel serving and non-serving cells, adjacent channel interference and thermal noise within the measurement bandwidth. Furthermore, network entity measurements component 90 may be configured to determine and store one or more additional measurements related to a UE signal strength 50. For example, network entity 14 (FIG. 1) may receive indication of or otherwise determine a detected signal strength of one or more UEs (e.g., including UE 12) based on a unit of measurement.

In additional aspects, network entity downlink enhancement detection component 34 may include comparator 96, which may be configured to compare one or more measurements received or otherwise obtained from the network entity measurements component 90 with one or more corresponding measurement thresholds. Comparator 96 may determine and/or store thresholds in measurement threshold component 98, including, but not limited to, an MCS threshold value 100 corresponding to the determined MCS value 92, a data rate threshold value 94 corresponding to a determined data rate value 94, an RSCP threshold value corresponding to the measured RSCP value 44, an SNR threshold value 60 corresponding to a measured SNR value 46, an RSSI threshold value 62 corresponding to a measured RSSI value 48 and a signal strength threshold value 64 corresponding to a measured signal strength value 50. For example, comparator 96 may be configured to determine whether a measured signal strength value 50 meets or exceeds a signal strength threshold value 64 and whether a UE downlink data rate (e.g., data rate value 94) meets or exceeds a UE downlink data rate threshold value (e.g., data rate threshold value 102). Further, for instance, comparator 96 may be configured to determine whether the MCS value 92 is less than or equal to the MCS threshold value 100. Moreover, when comparator 96 determines that at least one threshold condition is met (e.g., MCS value 92<=MCS threshold value), comparator 96 signals or otherwise provides a downlink enhancement condition 104 so as to trigger the transmission of TS bitmap message 76. In other words, network entity downlink enhancement detection component 34 through the operation of comparator 96 and generation of downlink enhancement condition 104 may determine the adequate condition or conditions for adjusting TS0 measurement periodicity.

In further aspects, network entity downlink enhancement component 32 may be configured to optionally receive a downlink enhancement message 28, as described herein, from a UE (e.g., UE 12, FIG. 1). In the aspects where UE 12 communicates downlink enhancement message 28, network entity downlink enhancement component 32 may receive and provide downlink enhancement message 28 to downlink enhancement authorization component 106, which may be configured to determine whether to authorize the TS0 measurement periodicity adjustment request included or formed as part of the TS0 measurement periodicity adjustment indication 68. For example, downlink enhancement authorization component 106 may, upon receiving downlink enhancement message 287, determine whether the request to adjust the TS0 measurement periodicity may be supported by the network entity (e.g., network entity 14). In other aspects, downlink enhancement authorization 106 may determine whether the UE is authorized or permitted to communicate with the network entity at higher data rates (e.g., HSDPA). In such aspects, for instance, downlink enhancement authorization 106 may determine whether to authorize an increase in the data rate by permitting allocation of at least one additional timeslot for downlink data communication.

In additional aspects, network entity downlink enhancement component 32 may be configured, upon detection of downlink enhancement condition 104 or upon authorization indication from downlink enhancement message authorization component 106, to send a network entity originated downlink enhancement message (e.g., TS bitmap message 76) to a UE (e.g., UE 12, FIG. 1). In some cases, TS bitmap message 76 may optionally include TS0 measurement periodicity adjustment authorization indication 78 authorizing downlink enhancement component 24 to adjust the TS0 measurement periodicity to the received adjusted measurement periodicity 80 for the indicated defined time duration 82. In some aspects, the received adjusted measurement periodicity 80 and the defined time duration 82 may be the same as or different from the adjusted measurement periodicity 70 and defined time duration 72 included in the downlink enhancement message 28. In other words, in some cases, the network entity may determine a different adjusted measurement periodicity 80 than the adjusted measurement periodicity 70 provided by the UE and/or a different defined time duration 82, as compared to the defined time duration 72, for the adjustment.

Further, in an aspect, the existence or absence of the TS0 measurement periodicity adjustment authorization indication 78 in the TS bitmap message 76 may indicate whether or not the downlink enhancement component 24 is authorized to adjust the TS0 measurement periodicity and/or the defined time duration. That is, the existence or absence of TS0 measurement periodicity adjustment authorization indication 78 may permit or not permit, respectively, an adjustment of a frequency of TS0 measurements per frame (e.g., adjusted measurement periodicity 70 or 80) for a defined time duration 72 or 82. Hence, for example, the TS bitmap message 76 may include a TS0 measurement periodicity authorization indication 78 when permitting an adjustment of the frequency of TS0 measurement per frame for the defined time duration. Further, for instance, the TS bitmap message 76 may include an absence of a TS0 measurement periodicity adjustment authorization indication 78 when not permitting an adjustment of the frequency of TS0 measurement per frame for the defined time duration.

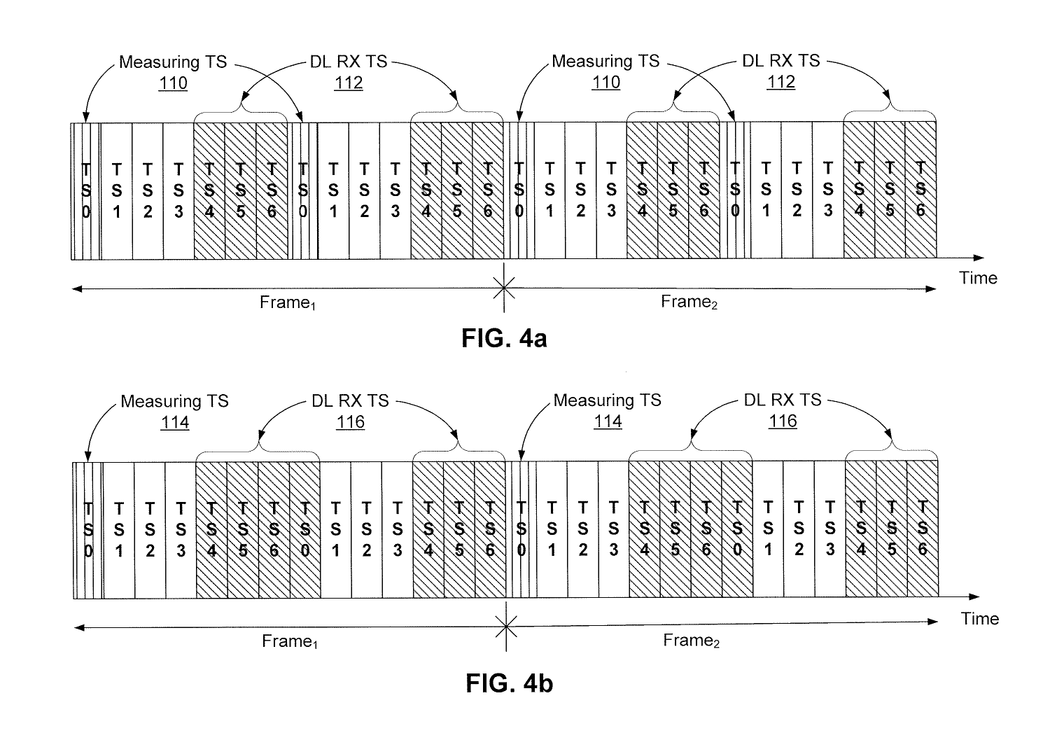

Referring to FIG. 4a, in an aspect, an example diagram of a time slot scheme for at least two frames is illustrated. In this example, every frame includes two subframes each having time slots TS0 to TS6. As described herein, TS0 may be designated for inter/intra frequency measurements. Further, TS1 to TS3 may be designated for uplink data communication, whereas TS4 to TS6 may be designated for downlink data communication. Every frame may, for instance, include two measuring TS 110 (e.g., two TS0 measurements). Accordingly, only six time slots are reserved for downlink communication, identified as DL RX TS 112.

Referring to FIG. 4b, in further aspects, an example diagram of an enhanced time slot scheme for at least two frames is illustrated. In this instance, every frame again includes at least two subframes each having time slots TS0 to TS6. However, in this example, only one TS0 measurement may be designated for measurements per frame. Hence, an adjustment of TS0 periodicity measurements may be made to allocate only one TS0 for measurements, and the other for downlink data communication for a define time duration (e.g., 10 frames or 50 ms). In such a non-limiting case, every frame may, for example, include one measuring TS 114. Accordingly, DL RX TS may now include seven time slots reserved for downlink communication (e.g., four DL RX TS for every other subframe in HSDPA).

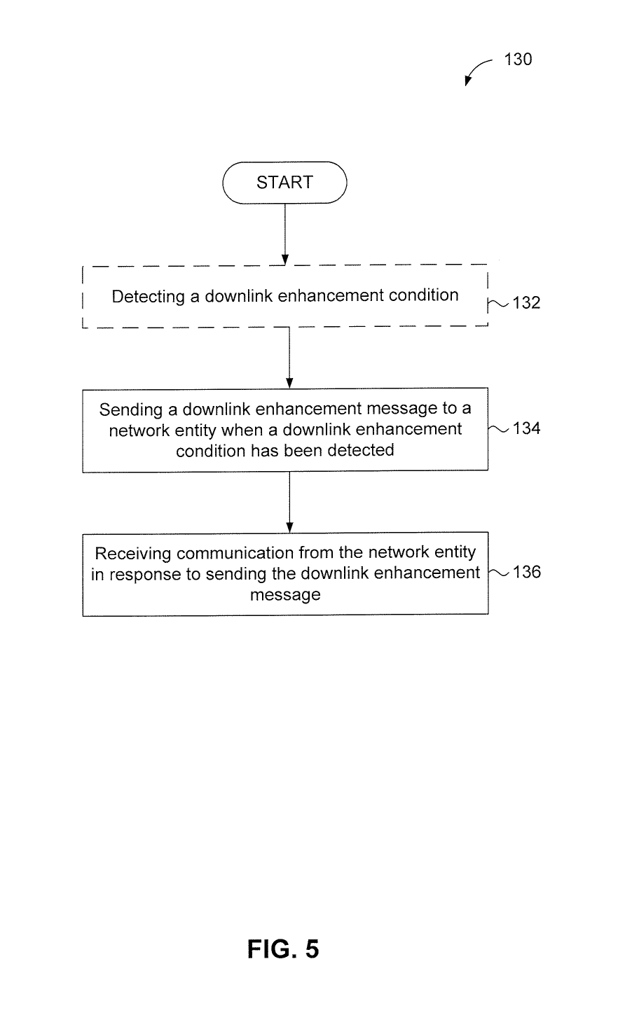

Referring to FIG. 5, in operation, a UE such as UE 12 (FIG. 1) may perform one aspect of a method 130 for enhancing downlink communication. While, for purposes of simplicity of explanation, the methods herein are shown and described as a series of acts, it is to be understood and appreciated that the methods are not limited by the order of acts, as some acts may, in accordance with one or more aspects, occur in different orders and/or concurrently with other acts from that shown and described herein. For example, it is to be appreciated that the methods could alternatively be represented as a series of interrelated states or events, such as in a state diagram. Moreover, not all illustrated acts may be required to implement a method in accordance with one or more features described herein.

In an aspect, at block 132, method 130 may optionally include detecting a downlink enhancement condition. For example, as described herein, downlink enhancement component 24 (FIGS. 1 and 2) may execute downlink enhancement detection component 26 to detect downlink enhancement condition 66. In some aspects, the downlink enhancement condition may include determining whether a measured signal strength value (e.g., signal strength 50. FIG. 2) meets or exceeds a signal strength threshold value (e.g., signal strength threshold value 64, FIG. 2). Further, for example, the measured signal strength value may be indicative of a RSCP. In addition, detecting the downlink enhancement condition may include determining whether a UE velocity value (e.g., velocity value 42, FIG. 2) is below UE velocity threshold value (e.g., velocity threshold value 56, FIG. 2).

Moreover, at block 134, method 130 may include sending a downlink enhancement message to a network entity when a downlink enhancement condition has been detected. For instance, as described herein, communication component 22 (FIG. 1) may execute downlink enhancement component 24 to send the downlink enhancement message 28 to the network entity (e.g., network entity 14, FIG. 1) when the downlink enhancement condition has been detected. In some aspects, the downlink enhancement condition may include a TS0 measurement periodicity adjustment indication. Moreover, for instance, the TS0 measurement periodicity adjustment indication requests network authorization of an adjustment of a frequency of TS0 measurements per frame for a defined time duration.

In addition, at block 136, method 130 may include receiving communication from the network entity in response to sending the downlink enhancement message. For example, as described herein, communication component 22 may execute downlink enhancement component 24 (FIGS. 1 and 2) to receive communication from the network entity (e.g., network entity 14, FIG. 1) in response to sending the downlink enhancement message 28. In some aspects, receiving communication from the network entity may include a TS bitmap message permitting or not permitting an adjustment of a frequency of TS0 measurements per frame for a defined time duration.

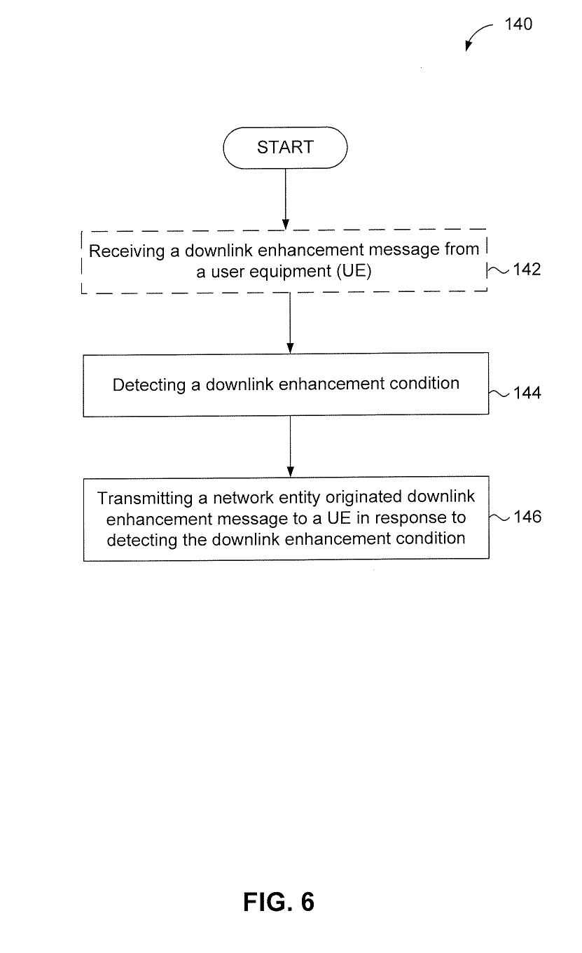

Referring to FIG. 6, in operation, a network entity such as network entity 14 (FIG. 1) may perform one aspect of method 140 to enhance downlink communication. In an aspect, at block 142, method 140 may optionally include receiving a downlink enhancement message from a UE. For instance, as described herein, network entity communication component 30 (FIGS. 1 and 3) may execute network entity downlink enhancement component 32 to receive the downlink enhancement message (e.g., measurement report message 74) from the UE (e.g., UE 12, FIG. 1). In such aspects,

Further, at block 144, method 140 may include detecting a downlink enhancement condition. For example, as described herein, network entity downlink enhancement component 32 (FIGS. 1 and 3) may execute network entity downlink enhancement detection component 34 to detect a downlink enhancement condition 104. In some aspects, detecting the downlink enhancement condition may include receiving the downlink enhancement message from the UE (block 142).

Moreover, at block 146, method 140 may include transmitting a network entity originated downlink enhancement message to a UE in response to detecting the downlink enhancement condition. For instance, as described herein, network entity communication component 30 (FIG. 1) may execute network entity downlink enhancement component 32 to send network originated downlink enhancement message (e.g., TS bitmap message 76, FIG. 3) to the UE (e.g., UE 12, FIG. 1) in response to detecting the downlink enhancement condition 104.

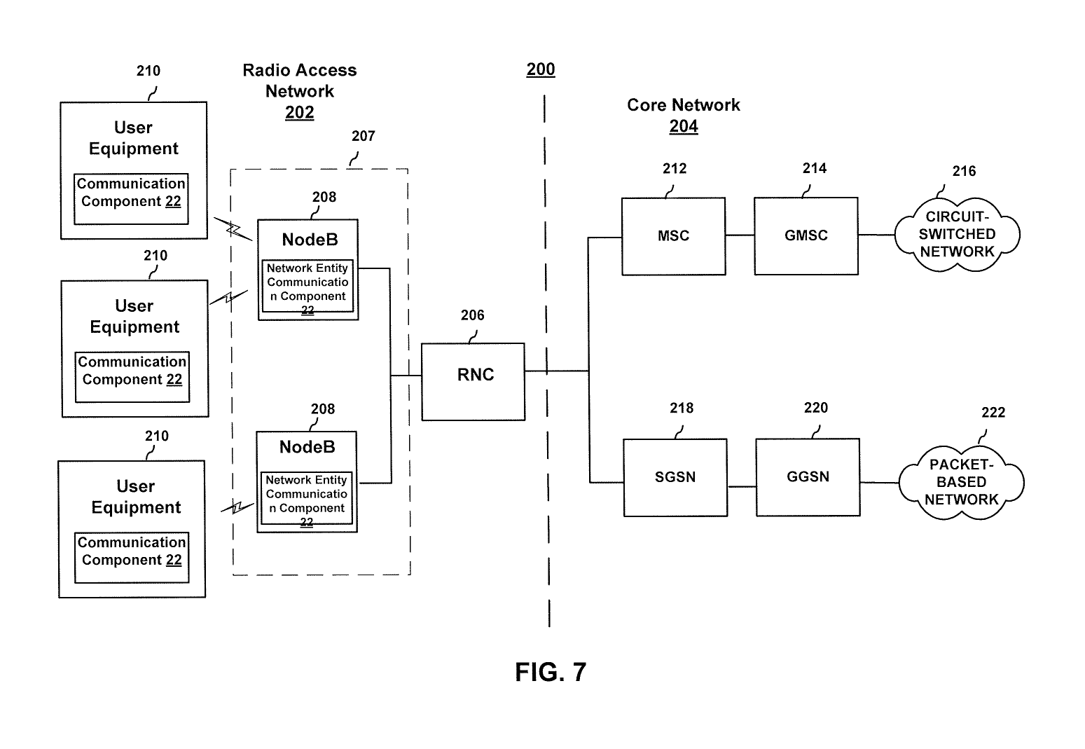

Turning now to FIG. 7, a block diagram is shown illustrating an example of a telecommunications system 200 in which UE 12 and network entity 14 discussed herein, and/or their corresponding communication component 22 and network entity communication component 30, may operate, such as in the form of or as a part of UEs 210 and Node Bs 208. The various concepts presented throughout this disclosure may be implemented across a broad variety of telecommunication systems, network architectures, and communication standards. By way of example and without limitation, the aspects of the present disclosure illustrated in FIG. 7 are presented with reference to a UMTS system employing a TD-SCDMA standard. In this example, the UMTS system includes a (radio access network) RAN 202 (e.g., UTRAN) that provides various wireless services including telephony, video, data, messaging, broadcasts, and/or other services. The RAN 202 may be divided into a number of Radio Network Subsystems (RNSs) such as an RNS 207, each controlled by a Radio Network Controller (RNC) such as an RNC 206. For clarity, only the RNC 206 and the RNS 207 are shown; however, the RAN 202 may include any number of RNCs and RNSs in addition to the RNC 206 and RNS 207. The RNC 206 is an apparatus responsible for, among other things, assigning, reconfiguring and releasing radio resources within the RNS 207. The RNC 206 may be interconnected to other RNCs (not shown) in the RAN 202 through various types of interfaces such as a direct physical connection, a virtual network, or the like, using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 208 are shown, each of which may include communication component 30 of network entity 14 (FIG. 1); however, the RNS 207 may include any number of wireless Node Bs. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 210 are shown in communication with the Node Bs 208, each of which may include communication component 22 of UE 12 (FIG. 1). The downlink (DL), also called the forward link, refers to the communication link from a Node B to a UE, and the uplink (UL), also called the reverse link, refers to the communication link from a UE to a Node B.

The core network 204, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 204 supports circuit-switched services with a mobile switching center (MSC) 212 and a gateway MSC (GMSC) 214. One or more RNCs, such as the RNC 206, may be connected to the MSC 212. The MSC 212 is an apparatus that controls call setup, call routing, and UE mobility functions. The MSC 212 also includes a visitor location register (VLR) (not shown) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR to determine the UE's location and forwards the call to the particular MSC serving that location.

The core network 204 also supports packet-data services with a serving GPRS support node (SGSN) 218 and a gateway GPRS support node (GGSN) 220. GPRS, which stands for General Packet Radio Service, is designed to provide packet-data services at speeds higher than those available with standard GSM circuit-switched data services. The GGSN 220 provides a connection for the RAN 202 to a packet-based network 222. The packet-based network 222 may be the Internet, a private data network, or some other suitable packet-based network. The primary function of the GGSN 220 is to provide the UEs 210 with packet-based network connectivity. Data packets are transferred between the GGSN 220 and the UEs 210 through the SGSN 218, which performs primarily the same functions in the packet-based domain as the MSC 212 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 208 and a UE 210, but divides uplink and downlink transmissions into different time slots in the carrier.

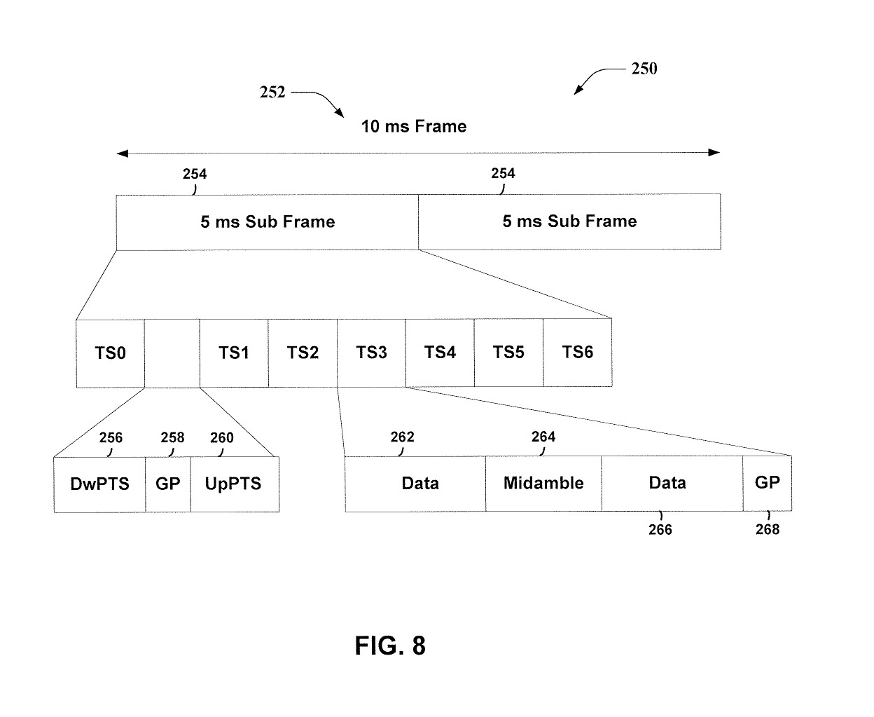

FIG. 8 shows a frame structure 250 for a TD-SCDMA carrier, which may be used in communications between UE 12 and network entity 14 discussed herein. The TD-SCDMA carrier, as illustrated, has a frame 252 that may be 10 ms in length. The frame 252 may have two 5 ms subframes 254, and each of the subframes 254 includes seven time slots, TS0 through TS6. The first time slot, TS0, may be allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 256, a guard period (GP) 258, and an uplink pilot time slot (UpPTS) 260 (also known as the uplink pilot channel (UpPCH)) are located between TS0 and TS1. Each time slot, TS0-TS6, may allow data transmission multiplexed on a maximum of, for instance, 16 code channels. Data transmission on a code channel includes two data portions 262 separated by a midamble 264 and followed by a guard period (GP) 268. The midamble 264 may be used for features, such as channel estimation, while the GP 268 may be used to avoid inter-burst interference.

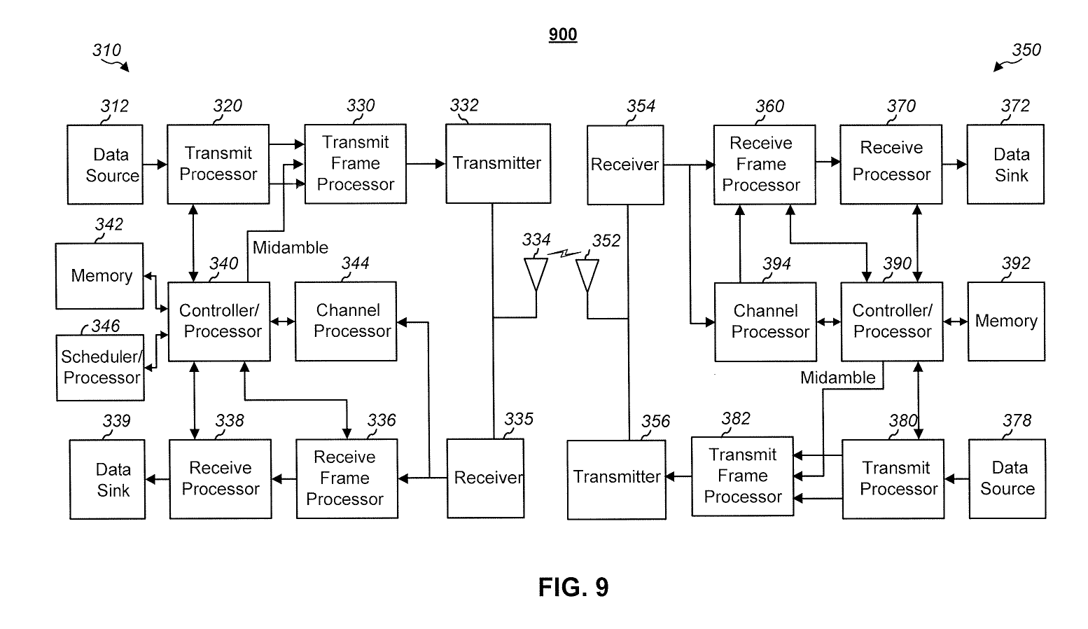

FIG. 9 is a block diagram of a Node B 310 in communication with a UE 350 in a RAN 300, where RAN 300 may be the same as or similar to RAN 202 in FIG. 7, the Node B 310 may be the same as or similar to Node B 208 in FIG. 7 or the network entity 14 in FIG. 1 including communication component 30, and the UE 350 may be the same as or similar to UE 210 in FIG. 7 or the UE 12 in FIG. 1 including communication component 22. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 8) from the UE 350. The symbols generated by the transmit processor 320 are provided to a transmit frame processor 330 to create a frame structure. The transmit frame processor 330 creates this frame structure by multiplexing the symbols with a midamble 214 (FIG. 8) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 8) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §212, sixth paragraph, unless the element is expressly recited using the phrase “means for” or, in the case of a method claim, the element is recited using the phrase “step for.”

What is claimed is:

1. A method of wireless communication at a user equipment (UE), comprising:
sending a downlink enhancement message to a network entity when a downlink enhancement condition has been detected; and
receiving communication from the network entity in response to sending the downlink enhancement message.

2. The method of claim 1, wherein the downlink enhancement message comprises a time slot zero (TS0) measurement periodicity adjustment indication.

3. The method of claim 2, wherein the TS0 measurement periodicity adjustment indication requests network authorization of an adjustment of a frequency of TS0 measurements per frame for a defined time duration, wherein the defined time duration is based on one or both of communication measurements and UE velocity.

4. The method of claim 2, wherein the TS0 measurement periodicity adjustment indication permits downlink allocation on at least one TS0 for a defined time duration.

5. The method of claim 1, wherein receiving communication from the network entity comprises receiving a time slot bitmap message permitting or not permitting an adjustment of a frequency of TS0 measurements per frame for a defined time duration.

6. The method of claim 5, wherein the time slot bitmap message comprises a TS0 measurement periodicity adjustment authorization indication when permitting the adjustment.

7. The method of claim 5, wherein the time slot bitmap message comprises an absence of a TS0 measurement periodicity adjustment authorization indication when not permitting the adjustment.

8. The method of claim 5, wherein the time slot bitmap message comprises a TS0 measurement periodicity adjustment authorization indication with a new defined time duration when permitting the adjustment.

9. The method of claim 8, wherein the new defined time duration is a network entity determined time duration permitting downlink allocation on at least one TS0 for the new defined time duration.

10. The method of claim 1, further comprising detecting the downlink enhancement condition based on determining whether a measured signal strength value meets or exceeds a signal strength threshold value, wherein the measured signal strength value is indicative of a received signal code power (RSCP).

11. The method of claim 1, further comprising detecting the downlink enhancement condition based on determining whether a UE velocity value is below a UE velocity threshold value.

12. A computer program product for wireless communication at a user equipment (UE), comprising:
a computer-readable medium including:
at least one instruction for sending a downlink enhancement message to a network entity when a downlink enhancement condition has been detected; and
at least one instruction for receiving communication from the network entity in response to sending the downlink enhancement message.

13. An apparatus for wireless communication at a user equipment (UE), comprising:
a downlink enhancement component configured to send a downlink enhancement message to a network entity when a downlink enhancement condition has been detected; and
the downlink enhancement component further configured to receive communication from the network entity in response to sending the downlink enhancement message.

14. The apparatus of claim 13, wherein the downlink enhancement message comprises a time slot zero (TS0) measurement periodicity adjustment indication.

15. The apparatus of claim 14, wherein the TS0 measurement periodicity adjustment indication requests network authorization of an adjustment of a frequency of TS0 measurements per frame for a defined time duration, wherein the defined time duration is based on one or both of communication measurements and UE velocity.

16. The apparatus of claim 14, wherein the TS0 measurement periodicity adjustment indication permits downlink allocation on at least one TS0 for a defined time duration.

17. The apparatus of claim 13, wherein to receive communication from the network entity the downlink enhancement component is further configured to receive a time slot bitmap message permitting or not permitting an adjustment of a frequency of TS0 measurements per frame for a defined time duration.

18. The apparatus of claim 17, wherein the time slot bitmap message comprises a TS0 measurement periodicity adjustment authorization indication when permitting the adjustment.

19. The apparatus of claim 17, wherein the time slot bitmap message comprises an absence of a TS0 measurement periodicity adjustment authorization indication when not permitting the adjustment.

20. The apparatus of claim 17, wherein the time slot bitmap message comprises a TS0 measurement periodicity adjustment authorization indication with a new defined time duration when permitting the adjustment.

21. The apparatus of claim 20, wherein the new defined time duration is a network entity determined time duration permitting downlink allocation on at least one TS0 for the new defined time duration.

22. The apparatus of claim 13, further comprising a downlink enhancement detection component configured to detect the downlink enhancement condition based on determining whether a measured signal strength value meets or exceeds a signal strength threshold value, wherein the measured signal strength value is indicative of a received signal code power (RSCP).

23. The apparatus of claim 13, further comprising a downlink enhancement detection component configured to detect the downlink enhancement condition based on determining whether a UE velocity value is below a UE velocity threshold value.

24. A method of wireless communication at a network entity, comprising:
detecting a downlink enhancement condition; and
transmitting a network entity originated downlink enhancement message to a user equipment (UE) in response to detecting the downlink enhancement condition.

25. The method of claim 24, wherein detecting the downlink enhancement condition comprises determining whether a modulation and coding scheme (MCS) value is less than or equal to an MCS threshold value.

26. The method of claim 24, wherein detecting the downlink enhancement condition comprises:
determining whether a UE measured signal strength value meets or exceeds a UE signal strength threshold value, and
determining whether a UE downlink data rate value meets or exceeds a UE downlink data rate threshold value.

27. The method of claim 24, wherein detecting the downlink enhancement condition comprises determining whether a downlink enhancement message is received from the UE.

28. The method of claim 27, wherein the downlink enhancement message comprises a TS0 measurement periodicity adjustment indication requesting network authorization of an adjustment of a frequency of TS0 measurements per frame for a defined time duration.

29. The method of claim 24, wherein the network entity originated downlink enhancement message comprises a time slot bitmap message permitting or not permitting an adjustment of a frequency of TS0 measurements per frame for a defined time duration.
